(19) United States
(12) Patent Application Publication
(10) Pub. No.: US 2013/0218907 A1
(43) Pub. Date: Aug. 22, 2013

(54) RECOMMENDER SYSTEM

(71) Applicants: Nir Nice, Kfar Veradim (IL); Shahar Keren, Petach Tikva (IL); Ori Folger, Tel Aviv (IL); Ulrich Paquet, Cambridge (GB); Shimon Shlevich, Nazareth Illit (IL); Noam Koenigstein, Ra'anana (IL); Eylon Yogev, Rehovot (IL)

(72) Inventors: Nir Nice, Kfar Veradim (IL); Shahar Keren, Petach Tikva (IL); Ori Folger, Tel Aviv (IL); Ulrich Paquet, Cambridge (GB); Shimon Shlevich, Nazareth Illit (IL); Noam Koenigstein, Ra'anana (IL); Eylon Yogev, Rehovot (IL)

(73) Assignee: MICROSOFT CORPORATION, Redmond, WA (US)

(21) Appl. No.: 13/400,581

(22) Filed: Feb. 21, 2012

(51) Int. Cl. G06F 17/30

(52) U.S. Cl. 707/751; 707/E17.089; 707/E17.084

(57) ABSTRACT

Embodiments of the invention provide methods and apparatus for recommending items from a catalog of items to users in a population of users by generating trait vectors that represent items in the catalog responsive to explicit and/or implicit preference data for a group of less than all the users and using the trait vectors to recommend items to users in the population that are not in the group.

### TECHNICAL FIELD

Embodiments of the invention relate to methods of recommending items for a person's use.

### BACKGROUND

Modern communication networks, such as mobile phone networks and the Internet, and the plethora of devices that provide access to services that they provide have inundated people with a surfeit of information and options for satisfying any from the simplest to the most complex needs and desires. Whereas in the not too distant past, information available to an individual was relatively sparse and generally expensive in time and/or resources to acquire, today, information is relatively inexpensive. All too often, the information is overwhelmingly abundant and diluted with irrelevant information.

For example, today a person interested in choosing a movie may receive for review via the Internet and mobile phone or cable networks, a bewildering number of recommendations for many tens, if not hundreds, of movies. Each movie may be accompanied with options for viewing at home, at conventional movie theaters, on a desktop computer, laptop, notebook, and/or on a smartphone. A person in transit, on foot or in a vehicle, using a laptop or smartphone, can easily request suggestions for a choice of coffee shops or restaurants to patronize, and may receive a list of recommended suggestions of confusing length. Whereas, the cost of acquiring information appears to have plummeted, the task of managing its copiousness to determine its relevance has become an increasingly complex and expensive task.

Various recommender systems and algorithms have been developed to attempt to deal with the challenges and opportunities that the abundance of inexpensive information has generated, and to automatically focus and filter information in order to recommend items for a user's consumption or use that match the user's interests and needs. The recommender systems and algorithms typically process explicit and/or implicit data acquired for a population of users to determine characteristics of the users and their consumer histories that may be used to infer their preferences for various items comprised in a catalog of items. Explicit data comprises information that a user consciously provides responsive to explicit requests for the data. Implicit data comprises data acquired responsive to observations of a user's behavior that are not consciously generated in response to an explicit request for data. Generally, processing the explicit and/or implicit data, hereinafter also referred to as “explicit-implicit data”, involves constructing a user-item model that generates representations for users in the population and items in the catalog, and provides rules for relating the representations that relate the users to the items. Applying the rules to relate the representation of a given user to representations of items, also referred to as “catalog items”, in the catalog identifies catalog items for recommendation to the user.

Many user-item models represent the users and the items by vectors and use inner products between vectors in the models to relate users in the user population with items in the catalog. In some user-item models, feature vectors represent users and items. Components of a feature vector representing a given user or given item generally indicate presence, or degree of presence of explicit features characterizing the given user or given item. In some user-item models, trait vectors in a latent space represent users and items. The latent space and the trait vectors may be determined by matrix factorization of a ranking matrix. A ranking matrix is a matrix in which elements of the matrix have values, which may be referred to as “rankings” or “preference rankings”, that rank preferences of users for items.

An amount of explicit-implicit data gathered and processed to construct a user-item model that may be used to recommend items to a user can be very large and may for example, involve processing data indicative of preferences for as many as a million or more users, for each of thousands of items. In practice, a computer having large processing resources is generally required to process the data and construct the user-item model. Often the model is not scalable. As a result, updating a first version of the user-item model to construct an adjusted second version of the model responsive to a marginal increase in an amount of data used to construct the first version may consume as much data processing resource as was consumed to construct the first version of the model.

### SUMMARY

An aspect of an embodiment of the invention, relates to providing a recommender system for a population of, “N”, users and a catalog of, “M”, items, and a scalable user-item model for configuring the recommender system that may be constructed using relatively moderate processing resources and represents the users and items with trait vectors in a latent space.

According to an embodiment of the invention, implementing the model comprises using explicit-implicit data acquired for the population to provide a ranking matrix comprising rankings for each of the M items by a group comprising a number of “P” selected users less than the total number of N users in the population of users. The P users are selected so that for each of the M items, a number of rankings in the ranking matrix is greater than a desired lower bound number of rankings. The ranking matrix so chosen represents a portion of the rankings that the explicit-implicit data provides for the N users and M items, and may be relatively small in comparison to a “global” ranking matrix representing rankings for all the N users and M items. However, because the users are selected to meet the lower bound constraint, the ranking matrix, hereinafter referred to as a “prime” ranking matrix “RP*”, will in general be relatively dense in comparison to the “global” ranking matrix.

In accordance with an embodiment, the prime ranking matrix is factorized using any matrix factorization algorithm to generate a “prime” items-matrix “IT*” comprising a set of M “prime” trait vectors respectively representing the M items. The N users are divided into groups of users and a user group ranking matrix, “RUG_{g}”, is provided for each user group responsive to the explicit-implicit data. Each user group ranking matrix RUG_{g} is factorized to determine a user group matrix “US_{g}” for the group assuming that the items-matrix for the group is the prime items-matrix IT*. The user group matrix USg comprises a user trait vector for each of the users in the user group that represents the user. Optionally factorizing is performed using the factorizing algorithm used to produce the prime items-matrix IT*.

In an embodiment, upper bound limits on changes in elements of the prime items-matrix IT* are determined for factorizing user group ranking matrices RUG_{g}. During factorizing of a user group ranking matrix RUG_{g}, if one or more iterations of the factorization algorithm introduces a change in the prime items-matrix IT* in excess of an upper bound limit, the change may be removed before carrying out a next iteration. In an embodiment an upper bound limit may be set to zero. A user matrix for the entire population of N users that comprises a trait vector for each user may be provided by combining the user trait vectors from all the user groups.

The number of user groups and a number of users comprised in each user group are determined in an embodiment of the invention so that the factorization of each of the user group ranking matrices RUG_{g} may be performed using a relatively moderate investment of processing resources. For example, the user groups may be configured, optionally by limiting a number of users in the groups, so that their respective user group ranking matrices RUG_{g} can be conveniently factorized using a desktop computer. In an embodiment of the invention a number of users in a user group may be limited to one user, and “group” may be used in the sense of a “set”, which may be a set of one member. In some embodiments, a plurality of user group ranking matrices RUG_{g} are factorized simultaneously using different computers. Adding user groups to accommodate additional users conveniently scales up the recommender system and the user-items model in accordance with an embodiment of the invention. Expanding the prime ranking matrix RP* in accordance with an embodiment of the invention to include additional items readily accomplishes scaling-up the recommender system and user-items model.

In the discussion, unless otherwise stated, adjectives such as “substantially” and “about” modifying a condition or relationship characteristic of a feature or features of an embodiment of the invention, are understood to mean that the condition or characteristic is defined to within tolerances that are acceptable for operation of the embodiment for an application for which it is intended.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF FIGURES

Non-limiting examples of embodiments of the invention are described below with reference to figures attached hereto that are listed following this paragraph. Identical structures, elements or parts that appear in more than one figure are generally labeled with a same numeral in all the figures in which they appear. Dimensions of components and features shown in the figures are chosen for convenience and clarity of presentation and are not necessarily shown to scale.

FIG. 1 shows a recommender system for recommending items to a user, in accordance with an embodiment of the invention;

FIG. 2 shows a flow diagram of a procedure for constructing a trait vector representation of users of the recommender system shown in FIG. 1 and items that the recommender system recommends, in accordance with an embodiment of the invention; and

FIG. 3A schematically shows a ranking matrix for all N users of the recommender system shown in FIG. 1 and all M items in a catalog from which the recommender systems recommends items in accordance with an embodiment of the invention; and

FIG. 3B schematically shows a prime ranking matrix, in accordance with an embodiment of the invention.

### DETAILED DESCRIPTION

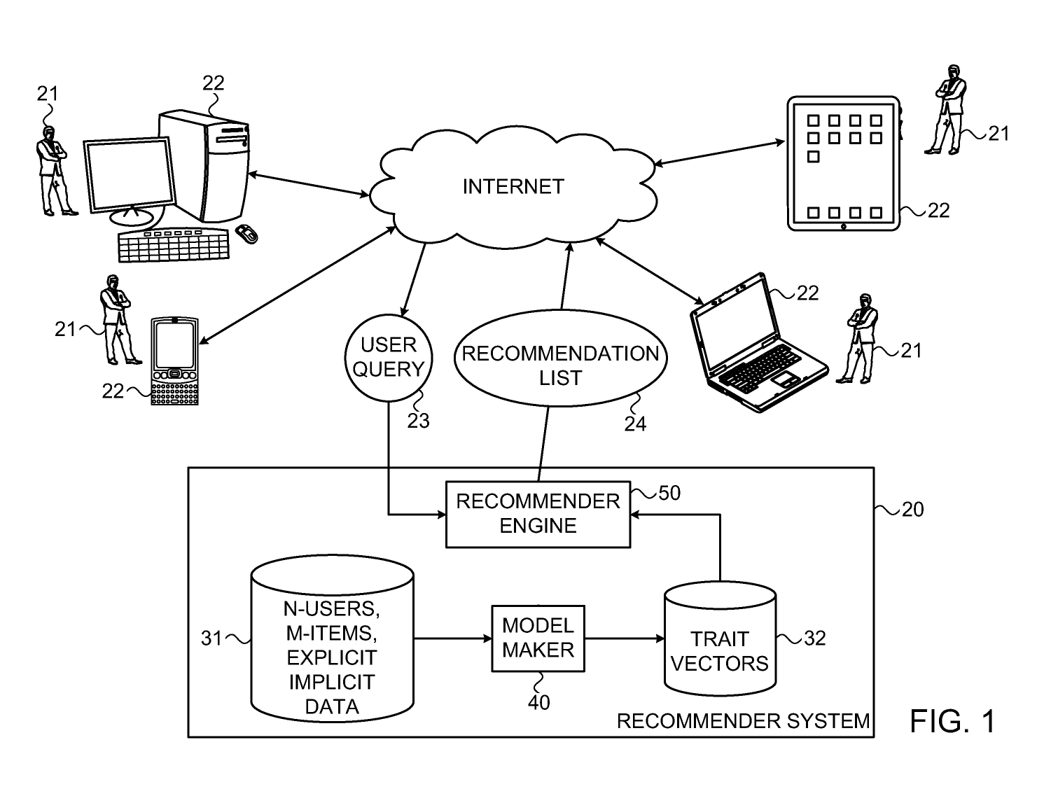

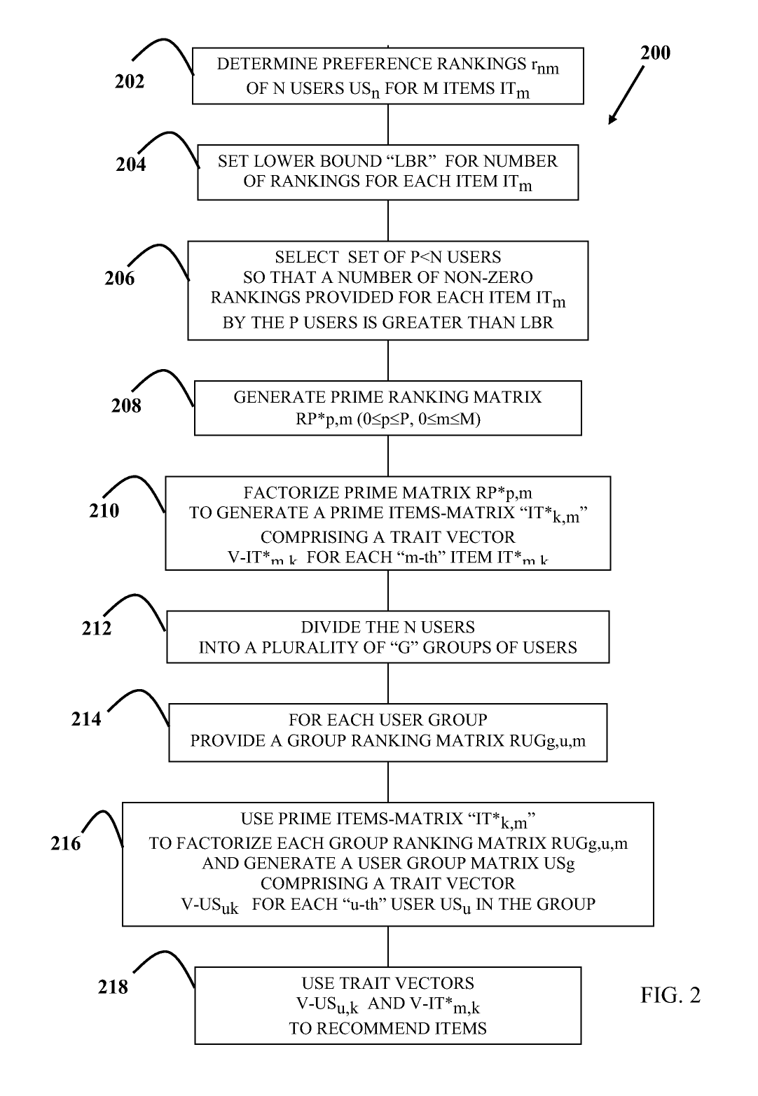

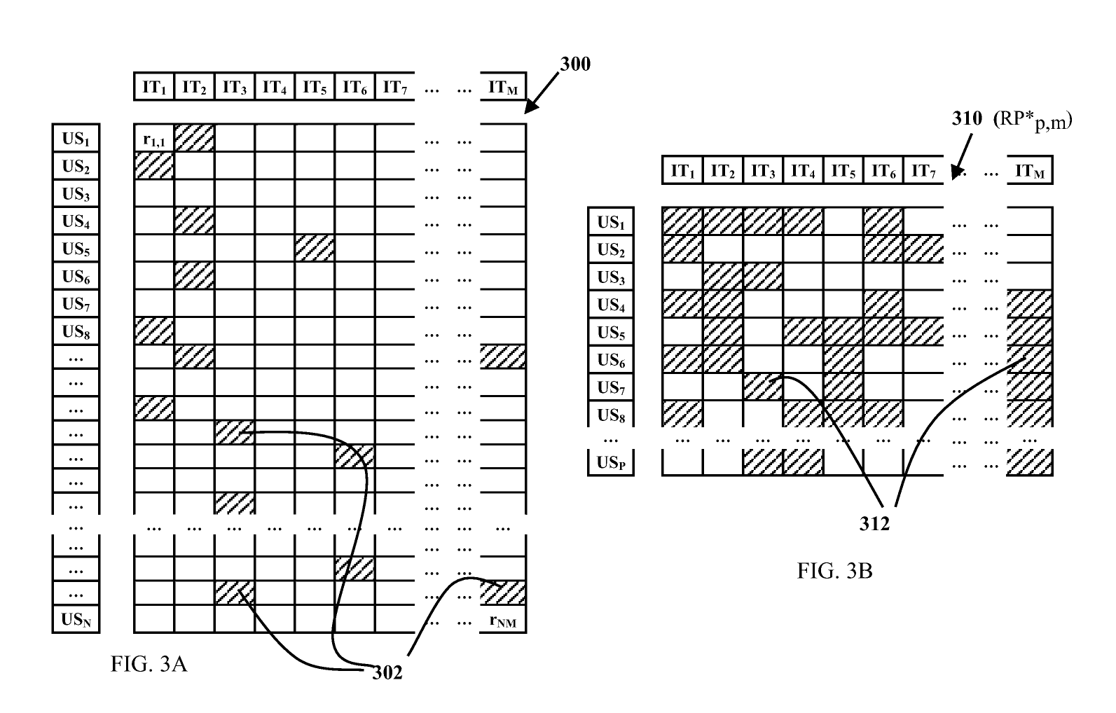

The detailed description below provides an overview of a recommender system in accordance with an embodiment of the invention and features of operation of a model maker and recommendation engine comprised in the recommender system in recommending items to a population of the system's users. The description references FIG. 1. A method by which the recommender system constructs a user-item model using advantageous methods for configuring ranking matrices to represent users and items by trait vectors in accordance with embodiments of the invention is described with reference to a flow diagram shown in FIG. 2. FIGS. 3A and 3B schematically show ranking matrices referred to in the discussion of the flow diagram. Indices associated with vectors and matrices referred to in the Summary that may not have been shown or explicitly referred to in the Summary, may for convenience of presentation be explicitly shown in the discussion below.

FIG. 1 schematically shows a recommender system 20 in accordance with an embodiment of the invention operating to provide recommendations to users 21 that may access the recommender system using any of various stationary or mobile communication devices, such as by way of example, a smartphone, laptop, notebook, or desktop computer. A user 21 may be any person who accesses recommender system 20, is accessed by the recommender system, and/or contributes explicit-implicit data to the recommender system. A numeral 22 labels the communication devices. Access to recommender system 20 may be via any suitable communication network to which the communication devices may connect, such as the Internet, a mobile phone network, or local area network (LAN). For convenience of presentation, the communication devices are schematically shown as communicating with recommender system 20 via the Internet.

Recommender system 20 optionally comprises an “explicit-implicit database” 31 comprising explicit-implicit data acquired responsive to preferences exhibited by a population of “N” users 21 for items in a catalog of “M” items. Recommender system 20 may comprise a model maker 40 that processes data in explicit-implicit database 31 to generate a database 32 comprising a trait vector for each of the N users and for each of the M catalog items. A recommender engine 50 uses the trait vectors in database 32 to recommend catalog items to users 21. Details of the generation of the trait vectors and their use in providing recommendations to users in accordance with embodiments of the invention are discussed below. In FIG. 1 recommender engine 50 is schematically shown receiving a user query 23 for a recommendation and responding with a recommendation list 24.

Explicit data optionally comprised in explicit-implicit database 31 includes information acquired by recommender system 20 responsive to explicit requests for information submitted to users 21 in the population. Explicit requests for information may comprise, by way of example, questions in a questionnaire, requests to rank a book or movie for its entertainment value, or requests to express an opinion on quality of a product. Implicit data optionally comprised in explicit-implicit database 31 includes data acquired by the recommender system responsive to observations of behavior of users 21 in the population that is not consciously generated by an explicit request for information. For example, implicit data may comprise data responsive to determining which catalog items a user 21 in the population views in an online store, how long a user 21 focuses on a particular catalog item, or to determining a pattern that a user 21 exhibits in choosing catalog items.

Model maker 40 processes explicit-implicit data comprised in explicit-implicit database 31 to provide each item “ITₘ” 1≦m≦M, and each user “USₙ” 1≦n≦N, with a trait vector in a latent space of “K” dimensions. Trait vectors for an item ITₘ and a user USₙ are respectively represented by V−IT_{m,k} and V-US_{n,k}, where the index “k” 1≦k≦K indicates a k-th component of the trait vectors in the latent space. Optionally, recommender engine 50 chooses an item ITₘ to recommend to a given user USₙ responsive to an inner product, IP(n,m)=Σₖ(V−US_{n,k}•V−IT*_{k,m}) of the given user's trait vector V−US_{n,k} with the item's trait vector V−IT*_{k,m}.

Recommender system 20 may provide recommendations to a population comprising at least about 1,000 users 21. Optionally, the population may comprise at least about 100,000 users 21. In an embodiment of the invention, the population comprises a number of users 21 that is equal to or greater than about 1,000,000. Optionally, a number of items in the catalog is equal to or greater than about 500 items. Optionally, the number of items is equal to or greater than about 5,000 items. In an embodiment, the number of items in the catalog is greater than or equal to about 10,000 items.

Whereas FIG. 1 schematically shows components of recommender system 20 inside a same frame, which may represent a server, the frame is not intended to indicate that the components have to be housed together or to be comprised in a same server. Practice of an embodiment of the invention is not limited to “centralized” recommender systems in which a same device houses all, or substantially all, the recommender system components or to recommender systems for which all the components are located at a same location. A recommender system in accordance with an embodiment of the invention may have a distributed configuration with hardware and software components at different locations. For example, explicit-implicit database 31 may reside in at least one first server, database 32 in at least one second server, and recommender engine 50 may reside in at least one third server, optionally all at different physical locations. Recommender system 20 may be cloud based and comprise components and processor executable instruction sets distributed over the Internet.

In an embodiment of the invention, model maker 40 and recommender engine 50 provide and use trait vectors V−IT_{m,k} and V−US_{n,k} in accordance with an algorithm similar to that illustrated by a flow diagram 200 in FIG. 2.

In a block 202 of flow diagram 200 model maker 40 processes explicit-implicit data in database 31 to determine preference rankings r_{n,m} of the N users USₙ of recommender system 20 for M items ITₘ in a catalog of items from which recommender system 20 chooses items for recommendation to users 21. A given preference ranking r_{n,m} may be any number in a scale of numbers that provides a measure of a degree to which the n-th user USₙ has exhibited a preference for the m-th item ITₘ. For example, a ranking may have a value that is a numerical rating assigned by a user to an item in response to a survey questionnaire indicating how satisfied the user was with the item. Or, a ranking value may be a number generated in response to how long the user and/or other users viewed an item in an online store. Explicit-implicit data with respect to the n-th user's preference for the m-th item, and therefore for the r_{n,m} ranking, may be lacking. A ranking r_{n,m} for which there is no explicit-implicit data, may be referred to as a “blank ranking”. A ranking r_{n,m} for which there is explicit-implicit data, may be referred to as a “non-blank ranking”.

In a block 204, model maker 40 sets a lower bound “LBR” for a number of non-blank rankings _{rn,m} for each item I_{Tm} that is to be used to determine trait vectors V−I_{Tk,m} and V−U_{Sn,k}. Optionally, the lower bound is the same for all items I_{Tm}. By way of a numerical example, in an embodiment of the invention LBR is equal to or greater than about 50. Optionally, LBR is equal to or greater than about 100. In some embodiments of the invent LBR is greater than or equal to about 200.

In a block 206, model maker 40 selects a set of “P” (P<N), users USₚ from among the N users USₙ to provide preference rankings rₚₘ for determining trait vectors V−IT_{m,k} and V−US_{n,k}. The selected users USₚ are chosen in accordance with an embodiment of the invention to attempt to provide a set of users for which a total number of rankings r_{p,m} that are not blank is greater than LBR for each item ITₘ. Subject to a successful selection of users, the rankings associated with the selected users provide elements for a prime ranking matrix RP*_{p,m} having a number of non-blank rankings r_{p,m} greater than or equal to the lower bound LBR for each item ITₘ. Assuming a conventional array of rows and columns of elements for prime ranking matrix RP*_{p,m}, a ranking, r_{p,m} is located in a “p-th” row and “m-th” column of the matrix, and each column in the prime ranking matrix RP*_{p,m} comprises at least LBR non-blank rankings. The prime ranking matrix will therefore in general be relatively dense in comparison to a global ranking matrix representing rankings for all of the N users and M items.

FIG. 3A schematically illustrates a global ranking matrix 300 comprising rankings r_{n,m} for all M items by all N users. Rankings in global ranking matrix 300 for items ITₘ that are associated with a same given user USₙ are given in an n-th row of the matrix, which is labeled by the corresponding user identifier “USₙ”. Rankings in global ranking matrix 300 for a same given item ITₘ provided by users USₙ are given in an m-th column of the matrix labeled by the corresponding item identifier “ITₘ”. Preference rankings r_{n,m} in ranking matrix 300 that are not blank are indicated by shaded cells 302 in the matrix. Because most users USₙ have experience with a relatively small number of items ITₘ, any given user USₙ generally provides a relatively small number of non-blank rankings rₙₘ to global matrix 300. As a result, global matrix 300, as shown in FIG. 3A, is a relatively sparse matrix and exhibits a relatively low density of shaded cells.

For comparison with global ranking matrix 300 a prime ranking matrix RP*_{p,m} 310 in accordance with an embodiment of the invention is schematically shown in FIG. 3B. Prime ranking matrix RP*_{p,m} 310 is relatively dense in comparison to global ranking matrix 300 and is schematically shown with a relatively high density of shaded cells 312. As noted above, selecting the P users to satisfy the constraint that a number of non-blank rankings for each item ITₘ in the prime ranking matrix RP*_{p,m} is equal to or greater than LBR produces the increased density of the prime ranking matrix.

It is noted that the subscripts associated with the row labels US₁, US₂, . . . and column labels IT₁ and IT₂ . . . , in matrices 300 and 310 refer to the order of the rows and columns respectively in the matrices, and same subscripts in the matrices do not necessarily refer to same users and catalog items respectively. Whereas in accordance with an embodiment of the invention matrices 300 and 310 have a same number of columns and homologous columns in the matrices may be associated with a same item ITₙ, the matrices do not have a same number of rows, and homologous rows in the matrices do not in general refer to same users.

Any of various methods may be used to select P users for prime ranking matrix RP*_{p,m} to satisfy the constraint that the matrix comprises at least LBR non-blank rankings for each item ITₘ. By way of example, in an embodiment of the invention, to provide the selected P users, an initial random selection of, “Pₒ”, users USₚ is made from the N users USₙ, and the ranking r_{p,m} associated with each of the selected users is used as an element of prime ranking matrix RP*_{p,m}. The prime ranking matrix RP*_{p,m} is then vetted to determine if it comprises an “underrepresented” item ITₘ for which a number of rankings is less than LBR. If an underrepresented item is found, a sufficient number of users USₙ that are associated with rankings for the underrepresented item that have not already contributed rankings to the prime ranking matrix are identified. Rankings r_{n,m} for the underrepresented item provided by the identified users USₙ are added as elements in the prime ranking matrix to satisfy the LBR constraint. The process of vetting the prime ranking matrix for an underrepresented item and adding rankings to satisfy the LBR constraint is repeated optionally until there are no underrepresented items in prime ranking matrix RP*_{p,m}, the prime ranking matrix has reached a desired upper bound size, or the constraint cannot be satisfied by the population of N users.

Following construction the prime ranking matrix RP*_{p,m}, is optionally factorized in a block 210 to generate a prime items-matrix “IT*_{k,m}” comprising a trait vector V−IT*_{k,m} for each “m-th” item ITₘ. Any of various factorization algorithms, such as a gradient descent or Bayesian based matrix factorization algorithm may be used to factorize RP*_{p,m}. Because prime ranking matrix RP*_{p,m} may be relatively small in comparison to a global ranking matrix for all the N users and M items, and may be relatively dense in comparison to the global ranking matrix, trait vectors V−IT*_{k,m} may be determined relatively rapidly with a moderate investment in processing resources. Because the prime ranking matrix RP*_{p,m} is constrained in an embodiment of the invention by the lower bound, LBR, to have a minimum amount of ranking information for each item ITₘ, trait vectors V−IT*_{k,m} may be advantageous representations of items ITₘ. By way of a numerical example, a number of users N may be equal to about 40,000,000, a number of items M may be equal to about 10,000 and a number P of users used to construct ranking matrix RP*_{p,m} may advantageously be equal to about 100,000. Matrix RP*_{p,m} may therefore be smaller by a factor of about 400 than the global matrix. As a result, for a given processor, advantageous trait vectors for items ITₘ may be determined using ranking matrix RP*_{p,m} in a period of time that may be shorter by a factor of about 400 than a period of time required to determine trait vectors using the global matrix.

In a block 212 the N users USₙ are divided into a plurality of G groups of users USₙ. Optionally, in a block 214 a group ranking matrix “RUG_{g,u,m}”, is provided for each user group. The group ranking matrix RUG_{g,u,m} comprises preference rankings for items ITₘ that are associated with the users in the group. In the expression, RUG_{g,u,m}, for the group ranking matrix, the index “g” 1≦g≦G identifies a “g-th” user group in the plurality of G user groups, the index “u” identifies a particular user, USᵤ, from the population of users USₙ that is included in the g-th user group, and “m” identifies a particular item ITₘ. For a given user group identified by a given index g, an entry in the user group ranking matrix RUG_{g,u,m} identified by a given index u and given index m provides a ranking r_{u,m} for the m-th item ITₘ by the u-th user USᵤ in the user group.

In a block 216 each user group ranking matrix RUG_{g,u,m} is factorized, using the prime items-matrix IT*_{k,m} and the vectors V−IT*_{k,m} that the prime items-matrix IT*_{k,m} comprises to represent items ITₘ. The factorization of each group ranking matrix RUG_{g,u,m} in accordance with an embodiment of the invention, provides a user group matrix US_{g,u,k} that defines a trait vector V−US_{u,k} (1≦k≦K) for each user USᵤ comprised in the user group. It is noted that factorizing each user group matrix RUG_{g,u,m} for the user group matrix US_{g,u,k} may simply involve solving a matrix equation RUG_{g,u,m}=Σₖ (US_{g,u,k} IT*_{k,m}). It is further noted that if a user “group” has only one member, RUG_{g,u,m} and US_{g,u,k} reduce to matrices containing only one row of elements, that is, they reduce to vectors.

In an embodiment, upper bound limits on changes in elements of the prime items-matrix IT*_{k,m} are determined for factorizing user group ranking matrices RUG_{g,u,m}. During factorizing of a user group matrix RUG_{g,u,m}, if one or more iterations of the factorization algorithm introduces a change in the prime items-matrix IT*_{k,m} in excess of a determined upper bound limit, the change may be removed before carrying out a next iteration. A user matrix for the entire population of N users that comprises a trait vector V−US_{n,k} for each user USₙ may be provided by combining the user trait vectors V−US_{u,k} from all the user groups.

In a block 218, recommender engine 50 uses a trait vector V−US_{n,k} representing a given user USₙ and trait vectors V−IT*_{k,m} representing items ITₘ, to recommend items to the given user. Optionally, recommender engine 50 chooses an item ITₘ to recommend to the given user responsive to an inner product, IP(n,m)=Σₖ(V−US_{n,k}•V−IT*_{k,m}) of the given user's trait vector V−US_{n,k} with the item's trait vector V−IT*_{k,m}.

For example, in an embodiment, recommender engine 50 determines inner products IP(n,m) for all items, that is for m=1 . . . M, and recommends to the given user items for which the magnitude of the inner product is greater than a predetermined threshold magnitude. Optionally, recommender engine 50 recommends items ITₘ from among a group of items ITₘ having largest inner products IP(n,m). For example recommender engine 50 may recommend items ITₘ from among those items having inner product IP(n,m) whose magnitudes are within a top 50 inner product magnitudes.

It is noted that n the above description a prime ranking matrix RP*_{p,m} is defined for all M items ITₘ (that is 1≦m≦M) in a catalog, and a number, P, of users USₚ less than all the N users in a population of users of recommender engine 20. However, embodiments of the invention are not limited to prime ranking matrices defined for all items in a catalog of items. For example, a prime ranking matrix may be constructed for less than M items by model maker 40 using a procedure similar to that illustrated by flow diagram 200 shown in FIG. 2 to define a first partial prime items-matrix “P₁−IT* comprising trait vectors for less than M items. The partial prime items-matrix may be expanded to provide trait vectors for additional catalog items by repeating the procedure using P₁−IT* expanded to accommodate additional trait vectors as an initial prime items-matrix.

In the description and claims of the present application, each of the verbs, “comprise” “include” and “have”, and conjugates thereof, are used to indicate that the object or objects of the verb are not necessarily a complete listing of components, elements or parts of the subject or subjects of the verb.

Descriptions of embodiments of the invention in the present application are provided by way of example and are not intended to limit the scope of the invention. The described embodiments comprise different features, not all of which are required in all embodiments of the invention. Some embodiments utilize only some of the features or possible combinations of the features. Variations of embodiments of the invention that are described, and embodiments of the invention comprising different combinations of features noted in the described embodiments, will occur to persons of the art. The scope of the invention is limited only by the claims.

1. A method of recommending items from a catalog of items to users in a population of users, the method comprising:
determining item trait vectors that represent the items responsive to rankings of the items associated with a first group of users comprising less than all the users in the population; and
using the item trait vectors to recommend items from the catalog to users in the population not in the first group.

2. A method according to claim 1 wherein determining item trait vectors comprises:
generating a first ranking matrix comprising rankings of the items associated with users in the first group; and
factorizing the first ranking matrix to determine an item trait vector for each of the catalog items that represents the catalog item.

3. A method according to claim 2 and comprising selecting users for the first group.

4. A method according to claim 3 wherein selecting users for the first group comprises selecting users so that a number of rankings in the first ranking matrix for which explicit-implicit information is available for each item is greater than a predetermined lower bound.

5. A method according to claim 4 wherein the lower bound is the same for all the items.

6. A method according to claim 2 wherein using the item trait vectors comprises:
selecting at least one second group of users comprising less than all the users from the population;
generating a second ranking matrix for each of the at least one second group comprising rankings associated with the users in the at least one second group; and
using the item trait vectors to factorize the at least one second group and provide a user trait vector for a user in the at least one second group that represents the user.

7. A method according to claim 6 and comprising setting an upper bound limit for a change in an element of an item trait vector that might occur responsive to using the item trait vectors to factorize the second ranking matrix.

8. A method according to claim 7 and comprising cancelling a change in the element if the change exceeds the at least one upper bound limit.

9. A method according to claim 6 wherein using the item trait vectors comprises determining an inner product of the user trait vector with at least one of the item trait vectors.

10. A method according to claim 9 and comprising using the inner product to recommend an item to the user represented by the user trait vector.

11. A method according to claim 6 wherein the at least one second group of users comprises a plurality of second groups of users.

12. A method according to claim 11 and comprising using a different processor to factorize each second ranking matrix generated for at least two of the plurality of second groups of users.

13. A method according to claim 12 and comprising factorizing the second ranking matrices generated for the at least two second groups of users substantially simultaneously.

14. A recommender system for recommending items from a catalog of items to a user in a population of users, the system comprising:
a model maker that determines item trait vectors that represent the items responsive to rankings of the items associated with a first group of users comprising less than all the users in the population; and
a recommender engine that uses the item trait vectors to recommend items from the catalog to users in the population not in the first group.

15. A recommender system according to claim 14 wherein the model maker generates a first ranking matrix comprising rankings of the items associated with users in the first group of users and factorizes the first ranking matrix to determine an item trait vector for each of the catalog items that represents the catalog item.

16. A recommender system according to claim 14 wherein the model maker selects users for the first group.

17. A recommender system according to claim 16 wherein the model maker selects the users so that a number of rankings in the first ranking matrix for which explicit-implicit information is available for each item is greater than a predetermined lower bound.

18. A recommender system according to claim 17 wherein the lower bound is the same for all the items.

19. A recommender system according to claim 14 wherein the model maker selects at least one second group of users comprising less than all the users from the population, generates a second ranking matrix for each of the at least one second group comprising rankings associated with the users in the at least one second group, and uses the item trait vectors to factorize the at least one second group and provide a user trait vector for a user in the at least one second group that represents the user.

20. A recommender system according to claim 19 wherein the recommender engine determines an inner product of the user trait vector with at least one of the item trait vectors and uses the inner product to recommend an item to the user represented by the user trait vector.
